(19) United States
(12) Patent Application Publication
(10) Pub. No.: US 2015/0098478 A1
(43) Pub. Date: Apr. 9, 2015

(54) MINIATURE TUNABLE DYE LASER

(71) Applicant: ISIS INNOVATION LIMITED, Oxford, Oxfordshire (GB)

(72) Inventors: Jason Michael Smith, Oxford (GB); Claire Vallance, Oxford (GB)

(73) Assignee: ISIS INNOVATION LIMITED, Oxford, Oxfordshire (GB)

(21) Appl. No.: 14/398,756

(22) PCT Filed: May 3, 2013
(86) PCT No.: PCT/GB2013/051166

§ 371 Date: Nov. 4, 2014

(30) Foreign Application Priority Data
May 4, 2012 (GB) 1207878.8

(51) Int. Cl. H01S 3/094; H01S 3/08; H01S 3/105; H01S 3/213

(52) U.S. Cl. CPC H01S 3/094034; H01S 3/213; H01S 3/08; H01S 3/105
USPC 372/20

(57) ABSTRACT

A miniature tunable dye laser comprises a pair of mirrors opposed along an optical axis and shaped to provide an optical cavity with stable resonance in at least one mode and having a cavity length of at most 50 μm. A laser dye is inside the optical cavity. A laser pump illuminates the dye with pump EM radiation having a band of wavelengths that is wider than the mode of said cavity An actuator system moves move the mirrors relative to each other along the length of the optical cavity for tuning the wavelength of the mode of said cavity.

The present invention relates to a tunable dye laser, and is particularly concerned with miniaturisation of the apparatus.

A dye laser uses an organic dye solution as the lasing medium. In any laser there are two requirements for achieving laser action, namely the ability to produce a population inversion in the laser medium, and the presence of an optical cavity to amplify the resulting stimulated emission.

To make a dye laser, the dye must be contained within an optical cavity. FIG. 8 shows a simple known configuration for a dye laser 100. In this case, the optical cavity 110 is formed by a two opposed mirrors 101 and 102, one mirror 101 being planar and the other mirror 102 being a diffraction grating, the mirror 101 and diffraction grating 102 being carefully aligned such that light entering the cavity 110 undergoes multiple reflections back and forth between the mirrors 101 and 102. The cavity contains optics 103 for expanding the beam onto the mirror 102 that is a diffraction grating. A laser dye 104 is contained within a cuvette 105 inside the cavity 110. By tilting the diffraction grating to the appropriate angle θ, the cavity 110 can be tuned for resonance with only a small range of wavelengths within the broadband emission of the dye 104. Within the cavity 110, the dye 104 is pumped by pump radiation 105 from a laser pump 106, and spontaneous emission yields the first few photons, which then lead to a cascade of stimulated emission from other molecules of the dye 104 within the cavity 110. The wavelengths resonant with the cavity 110 are reflected back and forth, causing further stimulated emission and rapid amplification of the emitted light, which emerges as a laser beam from the partially reflecting output mirror.

Many different laser dyes have been developed, spanning all of the visible and well into the infrared regions of the electromagnetic spectrum, and the output from a dye laser is often used in frequency doubling or frequency mixing schemes in order to generate wavelengths in the UV or mid-infrared. A single dye usually provides a tuning range of a few tens of nanometers, with a bandwidth determined largely by the cavity configuration. High-end dye lasers typically have a wavelength resolution ranging from sub-nanometer for cavities employing a prism as the tuning element down to a few picometres for a double grating arrangement. The broad tunability, high pulse energies, and narrow bandwidths achievable with dye lasers has made them the workhorses of laser spectroscopy. More recently, dye lasers have also found applications in laser medicine, due to the ability to wavelength-match their output to the absorption profile of specific tissues while minimising damage to other tissues. For example, dye lasers are used to treat kidney stones, port wine stains and various other blood vessel disorders, and for tattoo removal.

However, known configurations of a tunable dye laser are relatively bulky and it is difficult to support single mode operation.

According to the present invention, there is provided a tunable dye laser comprising:

a pair of mirrors opposed along an optical axis and shaped to provide an optical cavity with stable resonance in at least one mode and having a cavity length of at most 50 μm;

an actuator system arranged to move the mirrors relative to each other along the length of the optical cavity for tuning the wavelength of the mode of said cavity;

a laser dye inside the optical cavity having transitions over a range of wavelengths matching wavelengths to which the mode of said cavity is tunable; and

a laser pump arranged to illuminate the dye with pump EM radiation having a band of wavelengths that is wider than the mode of said cavity.

The present invention forms a laser cavity based on a micrometer scale optical microcavity. The use of the microcavity not only reduces the mode volume, but increases the Free Spectral Range (FSR), thereby facilitating laser operation at a single mode of the optical cavity. Accordingly, this form of optical filter offers a relatively narrow transmission band. Furthermore, this is provided in a simple, inexpensive device.

Furthermore, the actuator system provides tuning of mode and hence the transmission band the over a wide wavelength range. The actuation system may be any system that is capable of moving the mirrors relative to each other, for example a piezoelectric actuator.

The tunable dye laser offers major opportunities for the development of miniaturised, portable tunable lasers for a broad range of applications.

Such systems can be fibre coupled to create a robust package, and can also be fabricated in arrays, offering possibilities for projection and display technologies.

The optical cavities may advantageously be designed to improve their spectral characteristics.

A number of configurations of the mirrors may be used to provide the optical cavity with a stable resonance for modes confined perpendicular to the optical axis between the mirrors. To provide such confinement, typically, at least one of the mirrors is concave. Stable resonant modes produced in this way are robust to misalignment of the two mirrors and to the angle of incidence of illuminating radiation. This allows the tunable dye laser to be designed to provide low lasing thresholds, reduced multimode emission for many typical laser dyes, and small required quantities of laser dye.

The cavity length may be reduced, for example to be at most 30 μm, preferably at most 10 μm to increase the FSR which increases their tuning range and increases the spectral separation of the modes confined perpendicular to the optical axis which aids in producing single mode transmission, and also reduces the mode volume.

Minimisation of the radius of curvature increases the spectral separation of the modes confined perpendicular to the optical axis which aids in producing single mode transmission, and also reduces the mode volume. In that case, the concave mirror preferably has a relatively low radius of curvature, for example at most 50 μm, preferably at most 30 μm or 10 μm or 3 μm.

Advantageously, one of the mirrors is concave and the other one of the mirrors is planar. This avoids the need to provide precision alignment of the mirror faces perpendicular to the optical axis between the mirrors in order to maintain a stable cavity mode.

Concave mirrors of small size may be formed by focussed ion beam milling.

Advantageously, the reflectivity of the mirrors is maximised in order to maximise the quality factor Q. This minimises the width of the modes and thereby provides increased sensitivity. Advantageously, the mirrors have a root-mean-square roughness of at most lnm, and/or a reflectance of at least 99%, preferably at least 99.5%. Advantageously to provide high reflectivity, the mirrors may be Bragg reflectors.

To allow better understanding, an embodiment of the present invention will now be described by way of non-limitative example with reference to the accompanying drawings, in which:

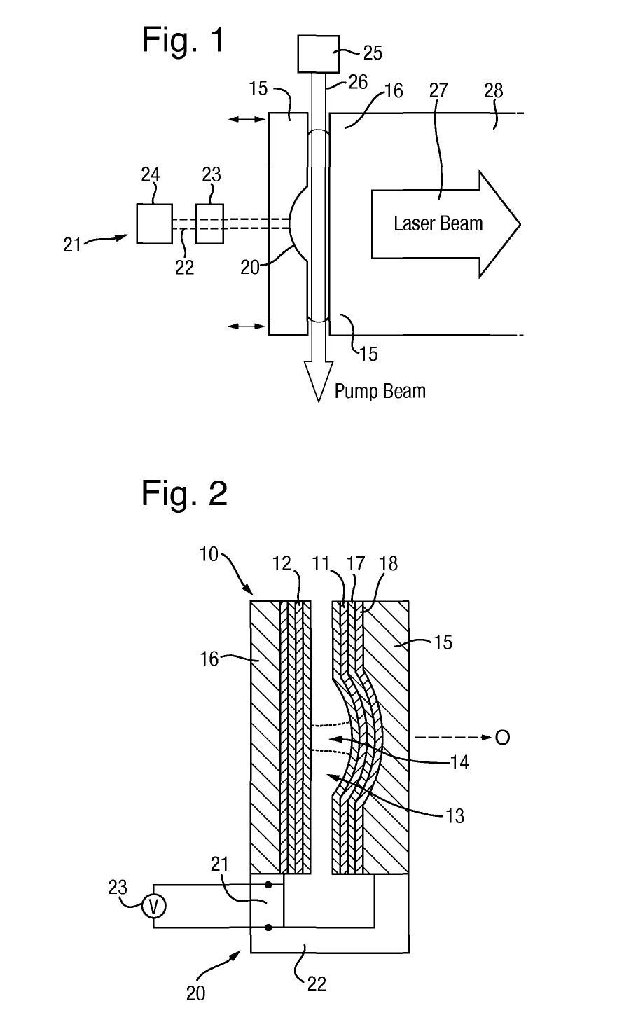

FIG. 1 is a diagram of a miniature tunable dye laser;

FIG. 2 is a side view of a cavity arrangement;

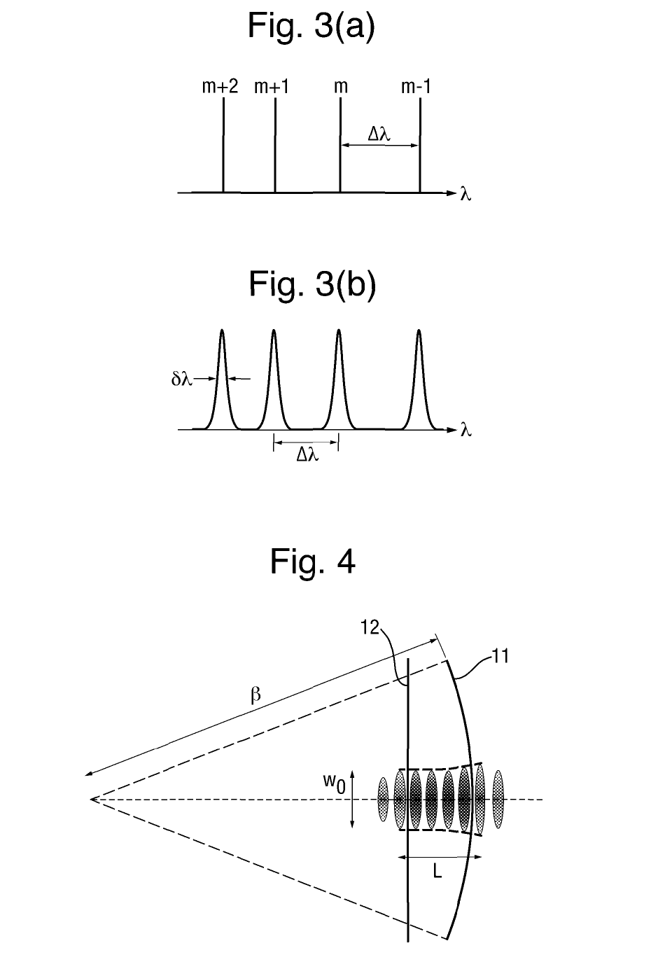

FIGS. 3(a) and 3(b) are plots of an intensity spectrum of an optical cavity with no losses and losses, respectively, illustrating the mode structure;

FIG. 4 is a side view of the optical cavity illustrating dimensional quantities;

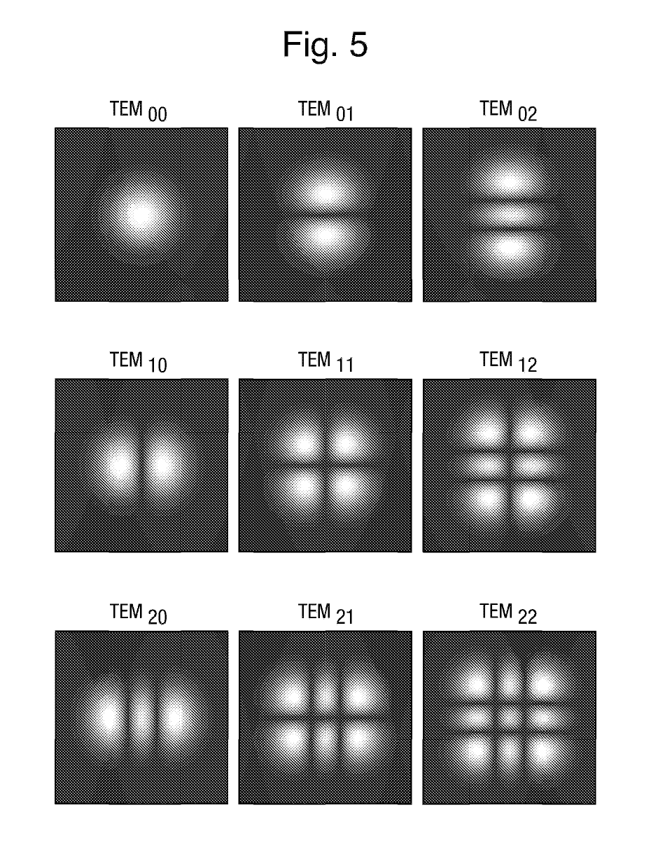

FIG. 5 is a set of plots of spatial distributions of the first nine Hermite-Gauss TEMₘₙ cavity modes perpendicular to the optical axis;

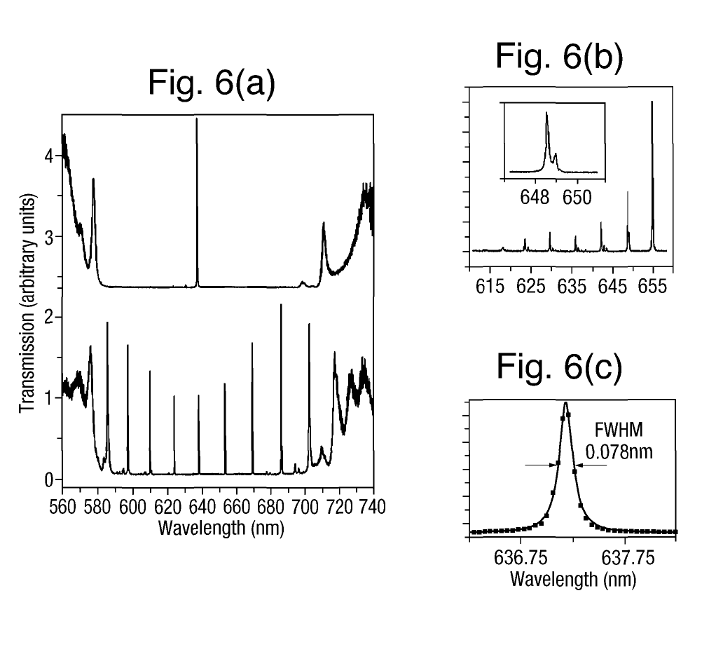

FIGS. 6(a) to (c) are measured transmission spectra of an optical cavity;

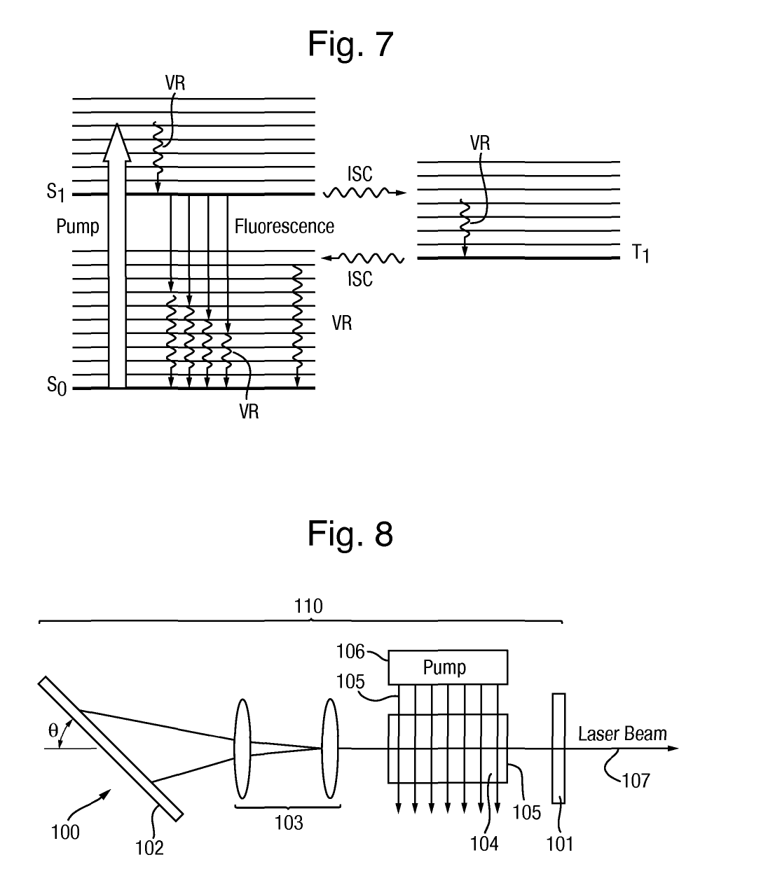

FIG. 7 is a diagram of the energy levels and photochemical processes in a typical organic dye; and

FIG. 8 is a schematic diagram of a known dye laser.

The present invention is applied generally to EM radiation including in any combination: ultraviolet light (which may be defined herein as having wavelengths in the range from 10 nm to 380 nm); visible light (which may be defined herein as having wavelengths in the range from 380 nm to 740 nm); infrared light (which may be defined herein as having wavelengths in the range from 740 nm to 300 μm); and/or other wavelengths. Herein, the terms ‘optical’ and ‘optics’ are used to refer generally to the EM radiation to which the invention is applied.

A laser 1 that is a miniature tunable dye laser is shown in FIG. 1. The laser 1 comprises a cavity arrangement 10 shown in detail in FIG. 2 and arranged as follows.

The cavity arrangement 10 is an open-access optical microcavity that comprises a pair of mirrors 11 and 12 opposing each other along the optical axis O. The microcavity is referred to as ‘open access’ because the mirrors 11 and 12 are open at the sides, transverse to the optical axis, thereby providing open access to the space therebetween.

The space between the mirrors 11 and 12 may be free space (vacuum), gas (e.g. air or other gas) or liquid.

The mirrors 11 and 12 are formed on substrates 15 and 16 and are shaped to provide an optical cavity 13 therebetween. An optical cavity confines EM radiation, such that the electromagnetic field has a stable resonance and forms standing waves of discrete frequencies and spatial distributions. Each standing wave state is known as a ‘mode’ of the EM field. For each mode, constructive interference of the electromagnetic waves occurs when a single ‘round trip’ of the cavity is described. The mirrors 11 and 12 are shaped so that the optical cavity 13 has stable resonance for at least one mode 14 that is confined in three dimensions, that is along and perpendicular to the optical axis O by reflection at the mirrors 11 and 12, as shown schematically in FIG. 2 (and also FIG. 4).

The cavity length L of the optical cavity 13 is the distance between the mirrors 11 and 12 including the field penetration into the mirrors 11 and 12.

There will now be given a general description of optical cavities that applies to the optical cavity 13.

By way of illustration for the confinement in the dimension along the optical axis O between the mirrors 11 and 12, the modes occur at wavelengths where the cavity length L (optical length of the cavity 13) is an integer number of half-wavelengths of the EM radiation, so that a round trip corresponds to an integer number of whole wavelengths. The criterion for a stable mode to exist in a planar Fabry Perot cavity may be written as

mλ=2L (1)

where m is an integer, λ is the optical wavelength inside the cavity and L is the cavity length. The mode wavelengths therefore form a series of discrete values corresponding to different values of m, as shown in FIG. 3(a) for the idealized cavity with no losses and in FIG. 3(b) for a real cavity with losses. In frequency space, the resulting cavity spectrum is often referred to as a ‘frequency comb’. For a given cavity, the lower limit of m may be 1, or the range of m values may be determined by the range of wavelength for which the mirrors 11 and 12 are reflective.

The Free Spectral Range (FSR) is the separation of the modes in wavelength space. For the illustrative one-dimensional example, the FSR is derived from equation 1 as

$$Δ λ = \frac{{λ}^{2}}{2 L} \qquad ( 2 )$$

Thus, the FSR can be seen to increase as the cavity length L is reduced. In general optical cavities with small cavity length L therefore contain fewer modes, spaced further apart in wavelength than the modes in optical cavities with large L.

The above text refers to a simple one-dimensional example, but the same principles apply for confinement in three dimensions in the optical cavity 13.

Equation 1 appears to imply that each individual mode (i.e. each value of m) has an exactly defined wavelength as shown in FIG. 3(a), but this simple picture is modified by leakage of EM radiation from the cavities, which results in each mode having a finite width δλ as shown in FIG. 3(b). This width δλ is related to the rate η at which photons leak from the cavity by the expression

$$δ λ = \frac{η {λ}^{2}}{2 π c} \qquad ( 3 )$$

where c is the speed of light in the cavity. The quality factor Q of a mode is defined as the ratio of the absolute resonant wavelength (the peak wavelength of the mode) and the mode width, that is

$$Q = \frac{λ}{δλ} = \frac{ω}{δω} \qquad ( 4 )$$

where ω is the angular frequency of the EM radiation in the cavity mode and δω is the mode width in angular frequency space. The quality factor Q is equivalent to the average number of optical cycles a photon undergoes within the cavity before it escapes. The quality factor may be attributed to the cavity itself, in which case it refers to the highest Q modes that the optical cavity supports.

Another important parameter for an optical cavity is the ‘mode volume’, which we label V. This represents the physical volume that is occupied by the majority of the energy in the optical mode. The energy density of an electromagnetic field is given by the product of the dielectric permittivity and the electric field intensity |E|². The mathematical definition of the mode volume is then the ratio of the total mode energy to the peak energy density, given by the equation:

$$V = \frac{\int \int {\int }_{allspace} ɛ ( {r}^{+} ) {\vert E ( {r}^{+} ) \vert}^{2} d V}{{( ɛ {\vert E \vert}^{2} )}_{max}} \qquad ( 5 )$$

Conversely, if the mode volume is known, then the maximum root-mean-square (rms) electric field can be calculated for a specified number N of photons present, based on the total energy of a mode containing this number of photons

$$ξ = \sqrt{\frac{( N + \frac{1}{2} ) ℏ ω}{ɛ V}} . \qquad ( 6 )$$

In general terms, the smallest resonant cavity that can be achieved theoretically is a cube of side length λ/2 with perfectly reflecting walls (no field penetration), giving a mode volume of

$$V = \frac{{λ}^{s}}{8} .$$

Many applications of optical cavities involve the interaction between the cavity field and electronic transitions of matter within the cavity. Electrons couple most strongly to electromagnetic radiation through the electric dipole interaction, whereby an electric dipole (a spatial separation of positive and negative charge) experiences a force due to the oscillating local electric field, whereby it can undergo a transition to a different state. For a transition dipole moment μ oriented parallel to the cavity field ξ, and energetically resonant with the optical mode, the strength of this coupling is characterised by the rate of energy transfer between the dipole and the field, known as the coherent coupling rate g.

$$g = \frac{μξ}{ℏ} = \sqrt{\frac{( N + \frac{1}{2} ) {μ}^{2} ω}{ℏ ɛ V}} \qquad ( 7 )$$

Qualitatively different behaviour occurs in the limits where (i) EM radiation leaks out of the cavity before it can be reabsorbed by the dipole (g<<η), and (ii) energy can transfer back and forth between the dipole and field before leaking from the cavity (g>>η). These are known as the ‘weak coupling’ and ‘strong coupling’ limits respectively. The criterion for strong coupling is therefore

$$\frac{Q}{\sqrt{V}} ≫ \sqrt{\frac{ℏ ωɛ}{{μ}^{2} ( N + \frac{1}{2} )}} . \qquad ( 8 )$$

The stringent requirement on cavity leakage makes strong coupling difficult to achieve.

In the weak coupling limit, the spontaneous emission rate of a resonant dipole is modified from the free-space value

$$γ = \frac{{μ}^{2} {ω}^{2}}{3 πɛ ℏ {c}^{2}} \qquad ( 9 )$$

to a new value

$${γ}^{′} = \frac{{g}^{2} ( v = 0 )}{2 x} = \frac{{μ}^{2} Q}{4 ℏ ɛ V} \qquad ( 10 )$$

that corresponds to an enhancement factor, known as the Purcell factor,

$${F}_{P} = \frac{{γ}^{′}}{γ} = \frac{3 {λ}^{2} Q}{4 {π}^{2} V} \qquad ( 11 )$$

This demonstrates that a cavity can modify the optical emission behaviour of a particle, of significance for applications in fluorescence detection and lasing. Importantly, equations 8 and 11 reveal that for strong coupling, or for modified spontaneous emission, large Q and small mode volume V are required.

The design parameters and general properties of the specific optical cavity 13 will now be described. In the following section there are described fabrication methods we use that allow us to combine mode volumes of order λ³ with values of the quality factor Q in excess of 10⁴.

In this example, three dimensional optical confinement is achieved by one mirror 11 being concave. The concave shape of the mirror 11 is spherical, but this is not essential and the mirror 12 could alternatively have another rotationally symmetric shape or a non-symmetric shape. The other mirror 12 is planar. An optical cavity 13 in which stable modes are formed is provided by a radius of curvature β of the concave mirror 11 being greater than the length L of the optical cavity 13, as illustrated in FIG. 4, as shown in FIG. 4.

As a result of the concave shape of the mirror 11, In addition to the longitudinal optical mode structure described above, the optical cavity 13 possess transverse electromagnetic modes with Hermite-Gauss mode structure as shown in FIG. 5. Each longitudinal mode has a fundamental transverse mode (TEM₀₀) and a family of transverse harmonics TEMₘₙ (integers m+n>0) at regular intervals on its short wavelength side. Some simple analytic equations can be used to describe this mode structure in the limit that β is significantly larger than L (known as the paraxial approximation).

The wavelength separation of the TEM modes with incrementing (m+n) is given by

$${Δλ}_{T} = \frac{{λ}^{2}}{2 π L} {cos}^{- 1} ( \sqrt{1 - \frac{L}{β}} ) \qquad ( 12 )$$

revealing that the mode separation increases as the radius of curvature decreases and as the cavity length decreases. For the TEM₀₀ modes the cross sectional intensity distribution is Gaussian in shape, and the beam waist is situated on the planar mirror.

The waist width w₀ (the minimum width of the optical mode being the width at the planar mirror 12) is given by

$${w}_{0}^{2} = \frac{λ L}{π} \sqrt{( \frac{β}{L} - 1 )} \qquad ( 13 )$$

whereby the mode volume is given by

$$V = \frac{π {w}_{0}^{2} L}{4} \qquad ( 14 )$$

Therefore, for example, a radius of curvature β=2λ combined with a cavity length L=λ would lead to a mode volume

$$V = \frac{{λ}^{s}}{4} .$$

The optical cavity has a cavity length of at most 50 μm, preferably at most 30 μm, more preferably at most 10 μm. Use of a microcavity with such a relatively short cavity length L increases the FSR, and also reduces the mode volume.

The concave mirror 11 has a radius of curvature of at most 50 μm, preferably at most 30 μm, more preferably at most 10 μm. Use of a microcavity with such a relatively short radius of curvature β increases the separation Δλ_{T} of the TEMₘₙ modes and may result in improved single mode transmission of EM radiation.

The mirrors 11 and 12 are formed to provide high reflectivity in order to maximise the quality factor Q. This minimises the width of the modes and thereby provides increased spectral resolution. Advantageously, the mirrors 11 and 12 have a reflectance of at least 99%, preferably at least 99.5%. To minimise losses, advantageously, the mirrors 11 and 12 have a root-mean-square roughness of at most 1 nm, and/or.

In particular the mirrors 11 and 12 may be Bragg reflectors. Such Bragg reflectors may comprise with multiple pairs of layers 17 and 18 alternating high and low refractive index dielectric material such as TiO₂/SiO₂, ZrO₂/SiO₂, Ta₂O₅/SiO₂, or ZnS/Al₂O₃. Each layer 17 and 18 is λ_{c}/4n thickness, where λₑ is the selected ‘centre wavelength’ for highest reflectivity and n is the refractive index of the layer. These combinations provide high index contrast resulting in small field penetration depths into the mirror, and low optical absorption at most optical wavelengths. A chosen mirror design (materials used, number of pairs) will determine the maximum reflectivity and the range of wavelengths (the band width) over which the mirrors are effective. This band width can typically be of order 100 nm for a mirror operating in the visible region of the spectrum.

As an alternative in some applications, the mirrors 11 and 12 may be metal mirrors, although these tend to absorb a few per cent of incident EM radiation at optical wavelengths and so are not suitable for the highest Q factor cavities.

A further limiting factor to the achievable reflectivity is scattering due to roughness of the coated surfaces. With a root-mean-square roughness a the maximum reflectivity that can be achieved is

$${R}_{max} = {e}^{- {( \frac{4 πσ}{λ} )}^{2}} . \qquad ( 13 )$$

For high reflectivities it is therefore desirable to be able to fabricate the concave surface with minimal roughness. Advantageously, the mirrors 11 and 12 have a root-mean-square roughness of at most 1 nm.

Other losses can be experienced due to edge effects if the concave mirror deviates from the ideal shape within the spatial extent of the mode.

The mirrors 11 and 12 have a reflectance of at least 99%, preferably at least 99.5%, but the reflectivity of such Bragg reflectors on substrates 15 and 16 of suitable material can reach 99.9999%, whereupon it generally becomes limited by trace absorption in the dielectric materials. Use of such relatively high reflectivities increase the quality factor Q.

In view of the above construction, the optical cavity 13 may be provided with a configuration providing small mode volumes and high quality factors Q. Therefore it is possible to provide the optical cavity with effectively a single mode within a wavelength band of interest.

The mirror 11 may be manufactured as follows.

The mirror 11 may be made using an etching technique to produce concave surfaces in silicon and thereby to fabricate cavities for single atom detection as disclosed in References [1] and [2] (that are incorporated herein by reference) (the References being cited at the end this description).

The mirror 11 may be formed by depositing mirrors onto convex surfaces such as silicon microlenses and then transfer them onto fibre tips using a lift-off technique as disclosed in Reference [3] (that is incorporated herein by reference).

The mirror 11 may be formed by using a bubble trapping method in glass to produce highly spherical surfaces with radii of curvature of order 50 μm, as disclosed in Reference [4] (that is incorporated herein by reference).

The mirror 11 may be formed by optical ablation of silica using a CO₂ laser, which has been demonstrated to be capable of providing Q factors of order 10⁶, and mode volumes as small as 2 μm³, as disclosed in Reference [5] (that is incorporated herein by reference).

The preferred method to form the mirror 11 is to use focussed ion beam milling. For example, it is possible to apply the technique disclosed in Reference [6] (that is incorporated herein by reference). In this example, a gallium beam of current 5 nA and acceleration voltage 30 kV is rastered over a planar substrate, modulating the dwell time between 0.1 ms and 50 ms at each point to produce the desired features. The advantage of this method is that control over the shape of the concave surface is achievable at the nanometer length scale, whilst retaining sub nanometer roughness. In this way concave features of any desired radius of curvature down to about 100 nm, or possibly less, can be achieved, and coated with high reflectivity mirrors. It should be noted that mirrors in the form of high reflectivity Bragg reflectors are typically a few micrometers thick, which may place a limitation on the minimum size of concave feature that would be preserved after coating. Nevertheless significant reductions in mode volume are possible using this technique, as compared to the other techniques mentioned above.

So far using this technique, the inventors have achieved mode volumes as small as 0.5 μm³, corresponding to ˜6λ³, at an operating wavelength of 440 nm in a 1.44 refractive index fluid, using a cavity with β=7 μm and L=1.6 μm. This mode volume has combined with a Q factor of 1000, and Q factors of up to 18,000 have been achieved using larger cavities.

The optical cavity 13 formed by a convex mirror 11 and a planar mirror 12 is advantageous in that the use of the planar mirror 12 avoids the need to provide alignment of the mirrors 11 and 12 perpendicular to the optical axis O between the mirrors 11 and 12. However, the mirrors 11 and 12 may have alternative shapes to provide an optical cavity. In general terms, the mirrors may each be curved with respective radii of curvature β and γ (where a planar mirror has an infinite radius of curvature, provided that in order to provide stable resonances, the mirrors 11 and 12 meet the requirement that 0≦[1−(L/β)]·[1−(L/γ)]≦1. Further details of alternative forms of the optical cavity 13 are given in Reference [7] (that is incorporated herein by reference).

To provide tuning of the wavelength of the modes of the optical cavity 30, the apparatus 1 is further provided with an actuator system 20 that is arranged to move the mirrors 11 and 12 relative to each other along the length of the optical cavity 13 between the mirrors 11 and 12. In particular, the actuator system 20 comprises a piezoelectric actuator 21 that is arranged between the mirrors 11 and 12 with extension parallel to the optical axis O. One of the mirrors 11 is mounted directly on a support 22 and the other mirror 12 is mounted on the support 22 by the piezoelectric actuator 21, although other constructions for mounting the piezoelectric actuator 21 between the mirrors 11 and 12 are possible. The piezoelectric actuator 21 is driven by a drive signal supplied from a drive circuit 23 to provide positional control.

The mode structure of the optical cavity 13 can be characterised by measuring the optical transmission spectrum for broad band incident EM radiation. By way of example, FIG. 6 shows some typical transmission spectra derived from an optical cavity 13 made by the technique disclosed in Reference [6], illustrating the tunability, quality factor, and Hermite Gauss mode structure. FIG. 6(a) shows the transmission spectra for two cavities each with β=7 μm at L=3.0 μm and L=12.3 μm, respectively. This shows how the FSR increases as L is reduced. FIG. 6 (b) is a close-up of the Hermite-Gauss mode structure from a single longitudinal mode. TEM₀₀ is at 655 nm, TEM₀₁ and TEM₁₀ are at 649 nm, etc. FIG. 6 (b) shows a splitting observed between with TEM₀₁ and TEM₁₀ resulting from a slight deviation from cylindrical symmetry. FIG. 6 (c) shows a high Q longitudinal resonance (scatter) with Lorentzian curve fit (solid line). The resolution of the spectrograph used for the measurements is about 0.05 nm, contributing substantially to the line width observed.

A laser dye 20 is disposed within the optical cavity 13. The laser dye 20 is an organic laser dye and a liquid. The laser dye 20 may be of any type. Typically, the laser dye 20 may typically have an energy level structure as shown in FIG. 7 and the following properties.

Organic laser dyes are relatively large molecules, possessing a dense manifold of vibrational and rotational states within each electronic state, as shown in FIG. 7. In solution, molecular energy levels are broadened by interactions with the solvent, and when averaged over many molecules the individual levels effectively coalesce to form a continuum. A high energy light source, either a flashlamp or a suitable pump laser, provides the energy required to ‘pump’ the dye from the S₀ electronic ground state to various rotational and vibrational levels of the first electronically excited singlet state S₁. Rapid vibrational relaxation (labelled VR in FIG. 7) via collisions with solvent molecules quickly transfers the molecule into the lowest vibrational level of the S₁ state, and there is now a population inversion between this level and excited rotational and vibrational states of the electronic ground state S₀. Thus there are transitions back down to any of these levels, down which the laser dye 20 can now fluoresce, yielding broad bandwidth emission over several tens of nanometers. This broad bandwidth emission in the absence of an optical cavity is the key to the tunability of dye lasers.

The laser dye 20 is selected to have transitions over a range of wavelengths matching wavelengths to which the mode of the optical cavity 13 is tunable. Typical laser dyes are available for lasing from 350 nm to 1000 nm.

The laser 1 comprises a circulation system 21 that is arranged to circulate the laser dye 20 through the optical cavity 13. This is straightforward due to the mirrors 11 and 12 providing open access to the space therebetween. The circulation system 21 may comprise a reservoir 24 containing fresh laser dye 20, fluidic channels 22 providing a flow path from the reservoir 24 between the mirrors 11 and 12 through the optical cavity 13 and a fluid pump 23 for pumping the laser dye 20 through the fluidic channels 22.

In addition to spontaneous and stimulated emission from the S₁ state to the S₀ state, excited dye molecules can also undergo a process known as intersystem crossing (labelled ISC in FIG. 7) to a lower lying triplet state, labelled T₁ in FIG. 7. Emission to the ground state from the triplet state is spin forbidden and very slow, and for this reason these states are often known as ‘dark states’. A buildup of these triplet states within the laser cavity would lead to rapid quenching of the dye laser action, and for this reason the dye solution is usually flowed through the pumping region from the reservoir 24, so that fresh dye is pumped on each cycle.

The laser 1 further comprises a laser pump 25 arranged to illuminate the laser dye 20 with pump EM radiation 26. The wavelength of the pump EM radiation 26 is selected to pump the laser dye from the S₀ electronic ground state to various rotational and vibrational levels of the first electronically excited singlet state S₁. The laser pump 26 may be of any type, for example laser such as a diode laser, microchip Nd:YAG laser, or other type of source. Even where the laser pump 25 is itself a laser, the laser pump 25 has a band of wavelengths that encompasses and is wider than one (or more) of the modes of the optical cavity 13.

In this example, the pump EM radiation 26 is directed into the optical cavity 13 parallel to the mirrors 11 and 12 (i.e. perpendicular to the cavity axis) so that it is not obstructed due to the open access configuration providing space between the mirrors 11 and 12. However, the pump EM radiation 26 could be directed in other configurations into the optical cavity 13, for example through one of the mirrors 11 or 12.

Within the cavity 13, the laser dye 20 is pumped by the EM pump radiation 26, and spontaneous emission yields the first few photons, which then lead to a cascade of stimulated emission from other molecules of the laser dye 20 within the cavity 13. The wavelengths resonant with the modes of the optical cavity 13 resonate back and forth, causing further stimulated emission and rapid amplification of the emitted EM radiation. The resultant EM radiation is output as a laser beam 27 through one of the mirrors 11 and 12, in this example the planar mirror 12, although it could alternatively be the concave mirror 11.

In this example, the support 16 on which the mirror 12 is formed is the end of an optical fibre 28. As a result the laser beam 26 is received by the optical fibre 28 and may be supplied through the optical fibre 28 to other components.

In order for the EM radiation to become ‘trapped’ within an optical cavity, it must undergo constructive interference within the mirrors, forming a standing wave. As discussed above this occurs, when the cavity length L matches an integer number of half wavelengths of the excitation light. The cavity 13 therefore supports a discrete spectrum, or ‘frequency comb’ of wavelengths, known as the longitudinal modes of the cavity. The modes are separated in frequency by the free spectral range (FSR) of the cavity, given by

$$Dn = \frac{c}{2 nL} \qquad ( 6 )$$

where c is the speed of light, L is the cavity length, and n is the refractive index of the medium within the cavity. For the relatively large cavities employed in most existing dye lasers, the cavity is very large relative to the wavelength of the excitation light, and the mode spacing is correspondingly small, with the result that many cavity modes are supported within the reflection band of the wavelength tuning element.

In contrast, in the laser 1, the cavity dimensions can become commensurate with the wavelength of the EM radiation, and so the free spectral range is sufficiently large that only the optical cavity 13 has a single mode, preferably the TEM₀₀ mode, within the range of wavelengths of the transitions of the laser dye 20 (i.e. the emission spectrum). Similarly a single cavity mode, preferably the TEM₀₀ mode, may be supported within the wavelength range over which the mirrors 11 and 12 are reflective. Furthermore, the resonant wavelength of the cavity mode may be tuned to any desired value simply by adjusting the cavity length L using the actuation system 20.

The lasing wavelength is selected by adjusting the cavity length, and the laser output from one of the cavity mirrors is either used directly or coupled into an optical fibre for delivery. In the latter case, one of the cavity mirrors could even be patterned directly onto the end of the delivery fibre.

The bandwidth of the laser 1 is determined by the Q factor of the optical cavity 13. A Q factor of 10⁴, as has already been achieved for a cavity arrangement manufactured using the method disclosed in Reference [7], yields cavity modes with a width of order 0.08 nm, while a cavity employing the best available mirror coatings, with a Q factor of around 10⁶, would have resonances of width 1 pm.

The pulse energy from the laser 1 depends on a number of parameters, and is somewhat harder to estimate. Assuming a typical dye concentration of order 1 g L⁻¹ for Rhodamine 6G, a common laser dye, we can determine the number of molecules of dye within the pump volume, and therefore the total number of photons per pulse that could be emitted if every molecule within the pump volume was excited, which is not an unreasonable possibility given the small pump volume. Rhodamine has a molecular mass of around 500 g mol⁻¹, yielding a molar concentration per cubic metre of 2 mol m⁻³. For a cavity with a concave mirror 11 of radius 20 μm and a cavity length L of order the cavity volume is of order 1×10⁻¹⁸ m⁻³, and it can therefore be calculated that there will be around 10⁶ molecules within the optical cavity 13 for a dye concentration of 1 g L⁻¹. Visible emission from this number of molecules corresponds to a pulse energy in the picojoule to nanojoule range.

For comparison, it is noted that Reference [7] reports a microfluidic dye laser pumped at 532 nm by a pulsed Nd:YAG laser lasing in Rhodamine 6G solutions of concentration 10⁻³M to 10⁻¹ M when the average pump power is raised above 1 mW, with an estimated a conversion efficiency for the dye laser of around 1% i.e. an output power of the order of 10 μW. At the kHz repetition rates of typical microchip Nd:YAG lasers, this corresponds to a pulse energy of a few nanojoules, in line with the calculation above.

The laser 1 offers major opportunities for the development of miniaturised, portable tunable lasers for a broad range of applications. Such systems can be fibre coupled to create a robust package, and can also be fabricated in arrays, offering intriguing possibilities for projection and display technologies.

The laser 1 has potential uses in a broad range of applications, including without limitation: (i) tunable light source for optical sensors and/or miniaturised high resolution spectroscopy; (ii) tunable light source for microfluidic applications; (iii) in consumer electronics; (iv) telecommunications; (v) endoscopy; and (vi) display and projection technology.

### REFERENCES

[1] M. Trupke, E. A. Hinds, S. Eriksson, E. A. Curtis, Z. Moktadir, E. Kukharenka, and M. Kraft, Appl Phys Lett 89, 211106 (2005)
[2] M. Trupke, J. Goldwin, B. Darquie, G. Dutier, S. Eriksson, J. Ashmore, and E. A. Hinds, Phys Rev Lett 99, 063601 (2007)
[3] T. Steinmetz, Y. Colombe, D. Hunger, T. W. Hansch, A. Balocchi, R. J. Warburton, and J. Reichel, Appl Phys Lett 89, 111110 (2006)
[4] G. Cui, J. M. Hannigan, R. Loeckenhoff, F. M. Matinaga, M. G. Raymer, S. Bhongale, M. Holland, S. Mosor, S. Chatterjee, H. M. Gibbs, and G. Khitrova, Optics Express 14, 2291 (2006)
[5] D Hunger et al, NJP 12, 065038 (2010)
[6] Dolan et al., “Femtoliter tunable optical cavity arrays”, Optics Letters, Vol. 35, No. 21, November 2010
[7] B. Helbo, S. Kragh, B. G. Kjeldsen, J. L. Reimers, and A. Kristensen, Sensors and Actuators A, 111 21 (2004)

1. A tunable dye laser comprising:
a pair of mirrors opposed along an optical axis and shaped to provide an optical cavity with stable resonance in at least one mode and having a cavity length of at most 50 μm;
an actuator system arranged to move the mirrors relative to each other along the length of the optical cavity for tuning the wavelength of the mode of said cavity;
a laser dye inside the optical cavity having transitions over a range of wavelengths matching wavelengths to which the mode of said cavity is tunable; and
a laser pump arranged to illuminate the dye with pump EM radiation having a band of wavelengths that is wider than a mode of said optical cavity.

2. A tunable dye laser according to claim 1, wherein said at least one mode is confined perpendicular to the optical axis between the mirrors.

3. A tunable dye laser according to claim 1, wherein at least one of the mirrors is concave.

4. A tunable dye laser according to claim 3, wherein said at least one of the mirrors that is concave has a radius of curvature of at most 50 μm, preferably at most 30 μm or 10 μm.

5. A tunable dye laser according to claim 3, wherein the mirrors have respective radii of curvature β and γ meeting the requirement that 0≦(1−(L/β))·(1−(L/γ))≦1.

6. A tunable dye laser according to claim 3, wherein one of the mirrors is concave and the other one of the mirrors is planar.

7. A method according to claim 3, wherein the at least one of the mirrors that is concave is formed by focussed ion beam milling.

8. A tunable dye laser according to claim 1, wherein the cavity length is at most 30 μm, preferably at most 10 μm.

9. A tunable dye laser according to claim 1, wherein said at least one mode includes a fundamental transverse mode of the optical cavity.

10. A tunable dye laser according to claim 1, wherein the laser dye is a liquid.

11. A tunable dye laser according to claim 1, further comprising a circulation system arranged to circulate the laser dye through the optical cavity.

12. A tunable dye laser according to claim 1, wherein the laser dye is an organic laser dye.

13. A tunable dye laser according to claim 1, further comprising an optical fibre arranged to receive EM radiation emitted through one of the mirrors.

14. A tunable dye laser according to claim 13, wherein the one of the mirrors is formed on the end of the optical fibre.

15. A tunable dye laser according to claim 1, wherein the mirrors have a root-mean-square roughness of at most 1 nm.

16. A tunable dye laser according to claim 1, wherein the mirrors have a reflectance of at least 99%, preferably at least 99.5%.

17. A tunable dye laser according to claim 1, wherein the mirrors are Bragg reflectors.

18. A tunable dye laser according to claim 1, wherein the optical cavity has a single mode within said range of wavelengths.

19. A tunable dye laser according to claim 1, wherein the actuation system comprises a piezoelectric actuator.
